(19) United States
(12) Patent Application Publication
(10) Pub. No.: US 2003/0208948 A1
(43) Pub. Date: Nov. 13, 2003

(54) Collapsible umbrella fishing rig

(76) Inventor: Glenn Higgins, Easton, MD (US)

Correspondence Address: Glen Higgins, 25948 St. Michaels rd., Easton, MD, 21601, US

(21) Appl. No.: 10/142,015

(22) Filed: May 10, 2002

(51) Int. Cl. A01K 91/00; A45B 3/00; A45B 5/00

(52) U.S. Cl. 43/42.74; 135/16

(57) ABSTRACT

An umbrella fishing rig with collapsible teaser arms is described.

### FIELD OF THE INVENTION

This invention relates generally to fishing tackle and equipment and more specifically to an improved umbrella rig for fishing.

### BACKGROUND OF THE INVENTION

It is often necessary in bay and ocean sport fishing to use an umbrella fishing rig to help attract game species.

When a fish strikes this umbrella fishing rig, however, it often becomes difficult for the fisherman to retrieve the fish due to the added resistance created by the teaser arms of the umbrella fishing rig teaser arms.

As seen in FIG. 1, a conventional umbrella fishing rig consists of a plurality of teaser arms 110 crossed at a 90-degree angle and held in place by a body of lead 120. A ring 105 is used to attach line from the fishing rod to the umbrella fishing rig.

As conventionally known, a lure with a hook (not shown) is attached to a ring 115. The teaser arms 110 shown in FIG. 1 carry a plurality of teaser lures (not shown). Conventional teaser lures do not include hooks as is well known in the art.

The umbrella fishing rig is trolled behind a boat. When a fish strikes, the fisherman then retrieves the rig, fighting not only the fish but also the added resistance of the teaser arms.

### SUMMARY OF THE INVENTION

Accordingly, it is desirable to be able to play the fish without the added resistance created by the teaser arms of a conventional umbrella fishing rig.

Teaser arms of conventional umbrella fishing rig devices are fixed in place and therefore cannot collapse in order to reduce resistance.

The umbrella rig of the present invention provides an improved operation/function by allowing the collapse of the teaser arms and a corresponding reduction in resistance through the water, thus making it easier to retrieve the fish.

The present invention includes an adjustable umbrella fishing rig, which enables the collapse of its teaser arms, after a fish has been hooked. The rig can include a conical body, a plurality of teaser arms, a shaft, a washer/disc, spring and two nuts. The washer/disc can be held in place on the shaft and in turn it can hold the plurality of teaser arms in place, inside the conical housing.

It is, therefore, an object of the present invention to provide an umbrella fishing rig with collapsible teaser arms.

It is another object of the present invention to provide a collapsible umbrella fishing rig having a plurality of teaser arms, each teaser arm having at least one teaser lure attached to each teaser arm, and further having a disc with a plurality of holes disposed in the disc, one hole of the plurality of holes being disposed in the center of the disc and having a shaft pass therethrough, each teaser arm passing through one of the plurality of holes and a final pair of holes for a release device, the shaft providing a means to connect the collapsible umbrella fishing rig to a fishing rod at one end and for carrying a pressure device and a retaining device for holding the pressure device on the shaft, further having a housing open on a first end and closed on a second end, wherein said shaft passes through a hole in the closed end and the disc is proximate to the open end, the pressure device is mounted on the shaft below the disc and proximate to the open end of the housing, the retaining device mounted on the shaft below the pressure device in order to retain the pressure device on the shaft and in order to provide an adjusting means for adjusting the pressure device, and further having a release device, such as a length of monofilament, attached though holes in the disc and attached to a lure by means of a swivel or other suitable means.

### BRIEF DESCRIPTION OF THE DRAWINGS

The invention can best be described with reference to the detailed description and the following figures where:

FIG. 1 is a conventional umbrella fishing rig.

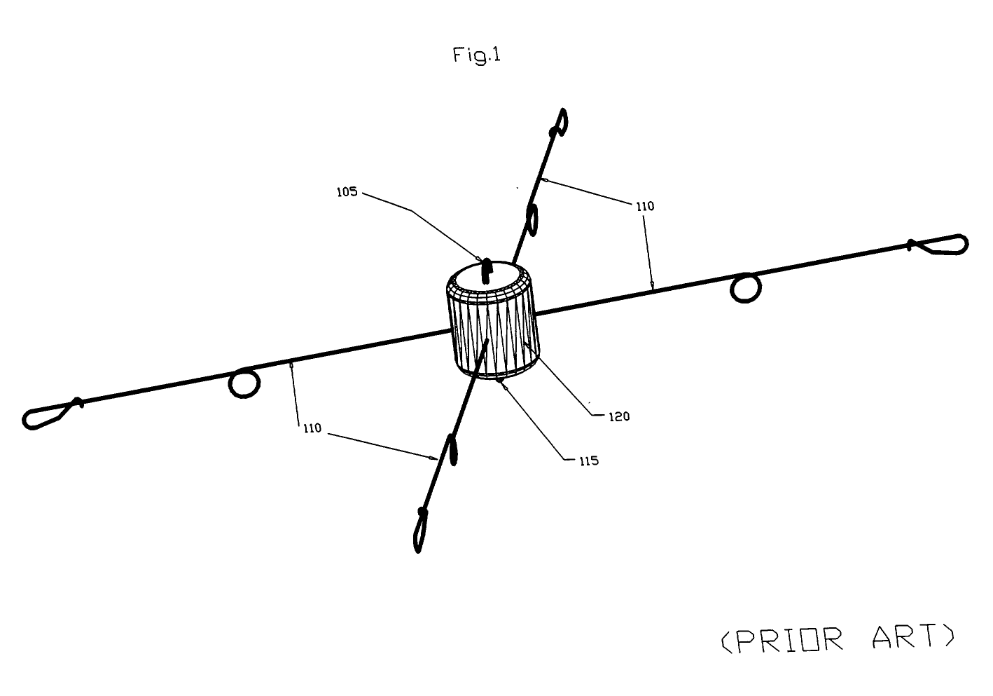

FIG. 2 shows a side elevation of a collapsible umbrella fishing rig according to the present invention.

FIG. 3 shows top elevation of the collapsible umbrella fishing rig of FIG. 2.

### DETAILED DESCRIPTION OF THE PREFERRED EMBODIMENTS

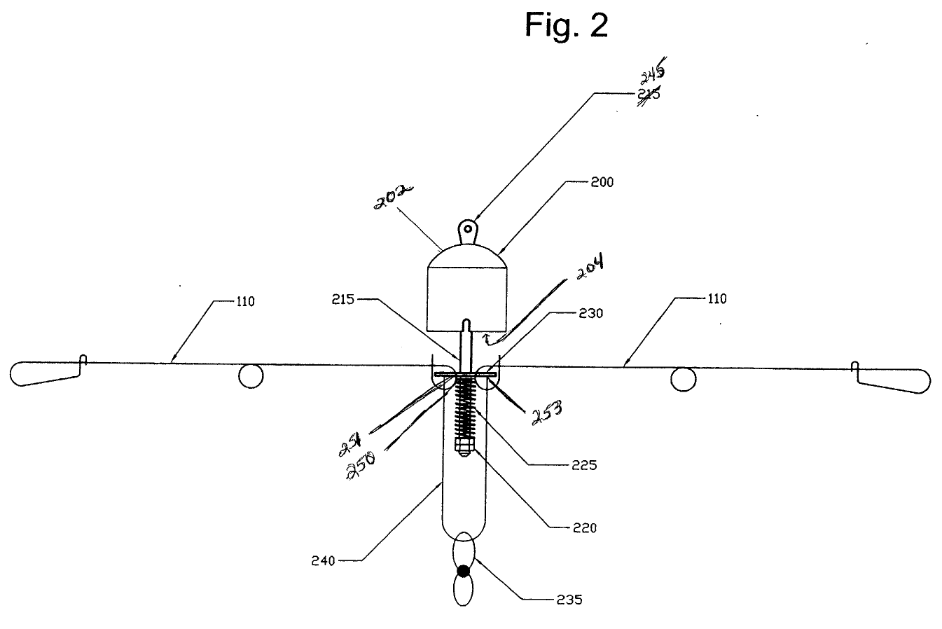

Referring now to FIG. 2, the collapsible umbrella fishing rig includes a housing 200, which has a hollow body open on one end 204 and closed on the other end 202. The housing could be made of plastic, metal, wood or other suitable material. The housing 200 is of any shape that would reduce resistance, such as conical or, as depicted in FIG. 2, cylindrical with a hemispheric top portion. A shaft 215 passes through the center of the closed end 202 of the housing 200 and out through the open end 204 of the housing 200. The end 245 of the shaft 215 that protrudes through the top of the closed end 202 of the housing 200 can be attached to the fishing rod (not shown) by using a hole drilled through shaft 215 or attaclunent of a swivel or other similar devices. The shaft 215 protrudes through a disc 230. The disc 230 has a plurality of holes 250 and 251. One center hole through which the shaft 215 passes and additional surrounding holes 251, which hold a plurality of teaser arms 110 by way of a loop in teaser arm 110, which passes through these surrounding holes 251 in disc 230. Additional holes 253 in disc 230 hold the release device 235, which includes of a swivel or some other known connector and a length of monofilament 240 or some other suitable material.

A pressure device 225 such as a spring or coil of wire or some other suitable material passes over the shaft 215 in a position adjacent to disc 230, but outward of the housing 200 and proximate the open end 204 of the housing 200.

A retaining device 220, can include a plurality of threaded nuts as shown in FIG. 2. Alternatively, the retaining device could include a pin through shaft 215 or some other known retaining member(s). The retaining device 220 may be made of metal or plastic or some other suitable material.

In preparation for use, a fishing line is attached to the shaft 215. Also, teasers—lures without hooks (not shown)—are attached to teaser arms 110 and a lure with a hook (not shown) is attached to release device 235. In use, the umbrella fishing rig is trolled behind a boat. When a fish strikes the lure (not shown) attached to release device 235, the resultant action forces the disc 230 back toward retaining device 220. The teaser arms 110 then collapse back in the direction of the release device 235 allowing the fisherman to retrieve the fish with less resistance than the conventional umbrella fishing rig.

In the collapsible umbrella fishing rig according to the present invention, the housing 200, shaft 215, pressure device 225, retaining device 220 and the teaser arms 110 can be made of any material able to withstand the environment of bay and ocean sport fishing, such as stainless steel, aluminum, bronze, plastic or rubber.

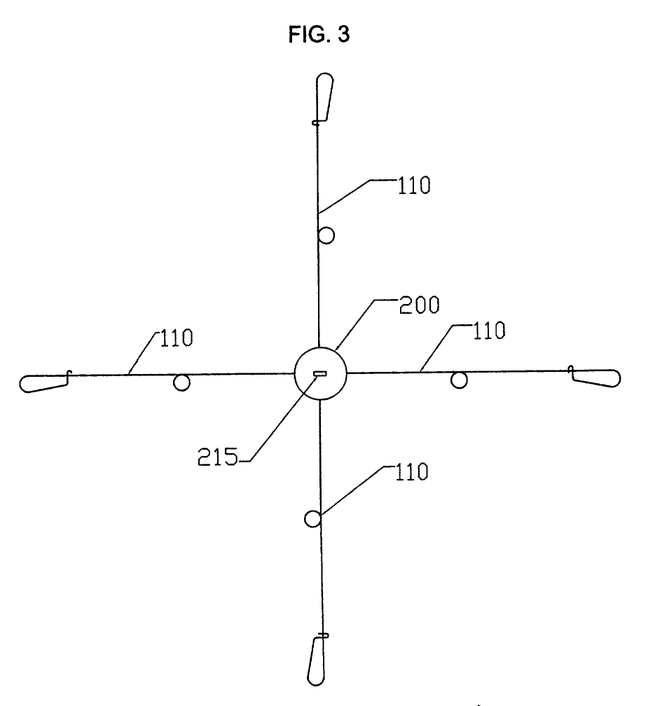

FIG. 3 illustrates a plurality of teaser arms 110 extending from the housing 200 in a deployed, uncollapsed state.

In operation, a fish strikes the bait attached to the fishing rig according to the present invention, the resultant pressure compresses the spring of the pressure device 225 and the teaser arms 110 collapse in the direction of the release device 235 as discussed above. The force required to compress this spring can be easily adjusted in the field to fit the intended catch.

It should be clear from the foregoing that the objectives of the invention have been met. While particular embodiments of the present invention have been described and illustrated, it should be noted that the inventions is not limited thereto since modifications may be made by persons skilled in the art. The present application contemplates any and all modifications within the spirit and scope of the underlying invention disclosed and claimed herein.

1. A plurality of teaser arms, each teaser arm having at least on teaser attached to each teaser arm; a disc with a plurality of holes, a center hole, one additional hole for each teaser arm and a plurality of hole to hold a release device; A shaft with a means to connect the line from a fishing rod; A housing, open on one end, closed on the other end with the shaft running through the closed end out through the center of the open end; A pressure device adjacent to the disc but opposite the open end of the housing; A retaining device adjacent to the pressure device on the shaft but opposite the disc; A release device attached to the disc through the above mentioned holes in the disc.

2. The collapsible umbrella rig, according to claim 1, wherein said housing shaft, pressure device, retaining device and teaser arms are stainless steel.

3. The collapsible umbrella rig, according to claim 1, wherein said housing shaft, pressure device, retaining device and teaser arms are plastic.

4. The collapsible umbrella rig, according to claim 1, wherein said housing shaft, pressure device, retaining device and teaser arms are rubber.

5. The collapsible umbrella rig, according to claim 1, wherein said housing shaft, pressure device, retaining device and teaser arms are bronze.

6. The collapsible umbrella rig, according to claim 1, wherein said housing shaft, pressure device, retaining device and teaser arms are aluminum.
